(19) United States
(12) Patent Application Publication
(10) Pub. No.: US 2015/0361955 A1
(43) Pub. Date: Dec. 17, 2015

(54) BLADE SPEED ADJUSTMENT DEVICE BY AUTOMATIC ADJUSTMENT OF THE BLADE ELEVATION ANGLE OF A WINDMILL GENERATOR

(71) Applicant: KUN SHAN UNIVERSITY, TAINAN CITY (TW)

(72) Inventor: SHUEEI-MUH LIN, TAINAN CITY (TW)

(21) Appl. No.: 14/301,440

(22) Filed: Jun. 11, 2014

(51) Int. Cl. F03D 7/02; F03D 7/04

(52) U.S. Cl. CPC F03D 7/024; F03D 7/0244; F03D 7/041

(57) ABSTRACT

A blade speed adjustment device by automatic adjustment of the blade elevation angle of a windmill generator and includes a casing, a first shaft extending through the casing, a slide and a passive member. The slide has at least one centrifugal unit including two links which are respectively connected to the casing and the passive member which has a rack. A bevel gear set has a second shaft which is perpendicularly engaged with the rack and located corresponding to the first shaft. The bevel gear set has a first bevel gear. The second shaft has a second bevel gear located corresponding to the first bevel gear. The centrifugal force of the block increases to move the rack, the elevation angle of the blade can be adjusted via the bevel gear set to maintain the elevation angle of the blade not to exceed the critical angle during strong wind.

### BACKGROUND OF THE INVENTION

1. Fields of the Invention

The present invention relates to a blade speed adjustment device by automatic adjustment of the blade elevation angle of a windmill generator to maintain the elevation angle of the blades so as to protect the blades from being damaged by strong wind.

2. Descriptions of Related Art

One of the commonly known method for obtaining green energy is to use wind to generate electric power. However, the wind speed is not controlled and the frequent change of the wind speed may reduce the efficiency of generation and/or damage the blades of the windmill generator.

The elevation angle, the length and the effective area of a blade can vary the speed of the blade. For a fixed wind speed, the larger the elevation angle of the blade is posed, the larger the torque and the resistance are generated. On the contrary, for a fixed wind speed, the less the elevation angle of the blade is posed, the less the torque and the resistance are generated. Accordingly, in order to obtain a better power generation efficiency, the rotation speed of the blades needs to be controlled, and which is related to the elevation angle, the length and the effective area of the blades. Among the factors mentioned above, the easiest way to obtain a better power generation efficiency is to adjust the elevation angle.

FIGS. 8 to 11 of Taiwan Patent Application No. 101134616 show an adjustment device for adjusting the elevation angle of blades, wherein the hydraulic pump provides hydraulic oil to the driving device to rotate the disk gear to adjust the elevation angle of the blade relative to the wind speed. In other words, when the blades and the first casing are co-rotated by the wind, the pump is driven by the difference of revolutions N1-N2 of the change of the wind speed so as to change the pressure P of the hydraulic oil that the pump provides, so as to change the angle θ of the disk gear and the co-moving part, and also to adjust the elevation angle β of the blades by mechanical way.

However, the change of the pressure of the hydraulic oil by the pump is difficult to control and the relative mechanism for controlling the pressure is complicated.

Another windmill generator uses an electric speed-reducing device to be located between the casing and the base to which the blades are connected. The electric speed-reducing device reduces the revolutions of the blades or the casing when the wind is too strong. However, the electric speed-reducing device consumes electric power and may be overheat if being operated for a period of time. If the wind is too strong and the electric speed-reducing device cannot to effectively reduce the revolutions of the blades or the casing, the electric speed-reducing device may be burned and the blades may be broken.

The present invention intends to provide a blade speed adjustment device by automatic adjustment of the blade elevation angle of a windmill generator to eliminate the shortcomings mentioned above.

### SUMMARY OF THE INVENTION

The present invention relates to a blade speed adjustment device and comprises a casing having a first shaft extending therethrough. The first shaft has a slide and a passive member connected thereto. The slide has at least one centrifugal unit which has a first link and a second link. The first link is fixed to the casing and the second link is connected to the passive member. The passive member has a rack. A bevel gear set has an axle and a second shaft, wherein the axle is perpendicular to the rack and the second shaft is located corresponding to the first shaft. The axle has a right gear and a first bevel gear, wherein the right gear is engaged with the rack. The second shaft has a second bevel gear located corresponding to the first bevel gear.

Preferably, the at least one centrifugal unit comprises a resilient member and a block. The resilient member is connected to the slide and the block is connected to a distal end of the resilient member. The block is connected to the first and second links.

Preferably, the slide has two centrifugal units connected thereto.

Preferably, the casing has a groove which is located corresponding to the rack. A distal end of the rack is movable located in the groove.

Preferably, the casing has a connection member connected thereto. The first shaft extends through the passive member and is pivotably connected to the connection member.

Preferably, the casing has a flange, and the first link is fixed to the flange of the casing.

Preferably, the casing has a recess and a resilient unit is located in the recess. The resilient unit is connected to a control pin which is received in a recess of the passive member.

Preferably, a mechanical brake device is located outside of the casing and brakes the casing by contacting the casing.

Preferably, a base is connected to the casing. The second shaft extends through the base and has a disk gear located in the base. Multiple blades are connected to the base and each blade has a toothed portion which is engaged with the disk gear.

Preferably, the first shaft is connected with a power generation device.

When the rotation speed of the casing is zero, the elevation angle of each of the blades is set to face the wind so as to generate torque, so that the blades rotate when wind blows to the blades. The rotation speed of the base increases to drive the blade speed adjustment device which is connected to the shaft by a key so that when the first shaft rotates, the power generation device is activated to generate power. When the first shaft rotates, the centrifugal force applied to the block increases. The distance between the block and the first shaft is represented as “D”. By the centrifugal force applied to the centrifugal unit, the passive member is pulled by the second link, and the rack drives the right gear to rotate the first bevel gear via the axle. The second bevel gear is then driven to make the second shaft rotate the disk gear. The rotation of the disk gear is rotated to drive the toothed portion of the blade to adjust the elevation angle of the blade. Therefore, the blade is adjusted to adjust the torque generated and to depress the increase of the rotation speed, such that the blades and the windmill generator are protected.

The centrifugal unit comprises a resilient member and a block. The resilient member is connected to the slide and the block is connected to the distal end of the resilient member. The block is connected to the first and second links. When the rotation speed of the present invention is larger than the initial rotation speed, the block is moved away from the first shaft due to the centrifugal force. The distance D increases and the resilient member is expanded. When the rotation speed of the present invention is less than the initial rotation speed, the block is moved toward the first shaft due to the less centrifugal force. The distance D decreases. The links moves the passive member and the rack according to the distance between the block and the first shaft, so as to rotate the right gear by the rack and to drive the first and second bevel gears. The disk gear and the second shaft are co-rotated. Eventually, when the angle of the disk gear reaches θ, the blades and the toothed portions pivoted an elevation angle of β. Therefore, the wind speed that is required to rotate the blades is reduced and the efficiency of generation is maintained.

The mechanical brake device is located outside of the casing and brakes the casing by contacting the casing. It is noted that the diameter of the casing is large and the casing is easily to be braked by the mechanical brake device, so that the casing is not damaged due to overly rotated.

The support body of the present invention also has a tail wing which pivots the support body according to the direction of the wind.

The present invention also provides an alternative blade speed adjustment device by automatic adjustment of the blade elevation angle of a windmill generator, wherein the existed blades are used which do not need to be re-designed with regard to the blade speed adjustment device. The casing has a recess and a resilient unit is located in the recess. The resilient unit is connected to a control pin which is received in a recess of the passive member. When the blades rotate due to the wind and the rotation speed of the blades is located within a pre-set range, the casing and the first shaft are co-rotated. Because the key is inserted into the recess of the passive member, so that the centrifugal unit cannot activate. In other words, the adjustment device for adjusting the elevation angle of the blades cannot operate. When the rotation speed reaches the critical value, the centrifugal force applied to the control pin is larger than the resilient force of the resilient unit, the control pin removed from the recess of the passive member, the centrifugal unit is activated to move the passive member, the blades are rotated to change the elevation angle so as to reduce the rotation speed.

The control key is cooperated with the centrifugal unit so as to be installed to the existed blades, the existed blades do not need to be re-designed and amended.

The advantages of the present invention are that the cooperation between the centrifugal unit and the bevel gear set makes the casing and the centrifugal unit to co-rotate when the wind operates the base. The centrifugal force changes the distance between the first shaft and the centrifugal unit, and the links pull the slide, the passive member and the rack so as to change the elevation angle of the blades by the bevel gear set, and the power generation device is activate to generate electric power. The elevation angle of the blades are adjusted by mechanical way according the wind speed. The elevation angle of the blades are adjusted to reduce the torque that he wind applies to the blades and the rotation of the speed of the blades to protect the windmill generator.

The present invention is able to mechanically adjust the elevation angle of the blades, and the mechanical brake device is located outside of the casing so as to brake the casing by contacting the casing. The diameter of the casing is large enough to provide sufficient area for the mechanical brake device to contact so that the casing is easily braked.

The present invention uses the blades that are cooperated with the blade speed adjustment device and the shape of each blade is designed to have a proper elevation angle when being rotated by the operation of the centrifugal unit when the wind speed changes. When the existed blades are used, the present invention also provide an alternative way to achieve the same purpose. A control key is used to remove from the recess of the passive member when the rotation speed reaches the critical value, so that the blades are rotated to change the elevation angle to reduce the torque that the wind applies to the blades. Therefore, the rotation speed and torque of the blades are reduced.

The primary object of the present invention is to provide a blade speed adjustment device by automatic adjustment of the blade elevation angle of a windmill generator, wherein the elevation angle of the blades is automatically adjusted according to the wind speed so as to protect the blades and the windmill generator.

Another object of the present invention is to provide a blade speed adjustment device by automatic adjustment of the blade elevation angle of a windmill generator, wherein the automatic adjustment to the blades is made by using at least one centrifugal unit.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the blade speed adjustment device of the present invention;

FIG. 2 is another exploded view of the blade speed adjustment device of the present invention;

FIG. 3 is a perspective view to show the blade speed adjustment device of the present invention;

FIG. 4 is a cross sectional view, taken along line A-A in FIG. 3;

FIG. 5 is the centrifugal unit of the blade speed adjustment device of the present invention;

FIGS. 6 and 7 show the actions of the centrifugal unit of the blade speed adjustment device of the present invention;

FIG. 8 shows that the actions of the blades and the disk gear when the centrifugal unit is activated;

FIG. 9 shows the relationship between the elevation angle and the rotation speed of the present invention and the conventional adjustment device;

FIG. 10 shows the relationship between the rotation speed and the wind speed of the blade speed adjustment device of the present invention;

FIG. 11 shows the mechanical brake device is installed outside of the casing of the blade speed adjustment device of the present invention;

FIG. 12 shows the centrifugal unit of the second embodiment of the present invention;

FIG. 13 is an exploded view of the centrifugal unit of the second embodiment of the present invention;

FIG. 14 is a cross sectional view of the second embodiment of the present invention;

FIG. 15 shows that the control pin in the second embodiment of the present invention is removed from the recess of the passive member when the centrifugal force of the control pin is larger than the resilient force of the resilient unit, and

FIG. 16 shows the action of the centrifugal unit of the second embodiment when the control pin is removed from the recess of the passive member.

### DETAILED DESCRIPTION OF THE PREFERRED EMBODIMENT

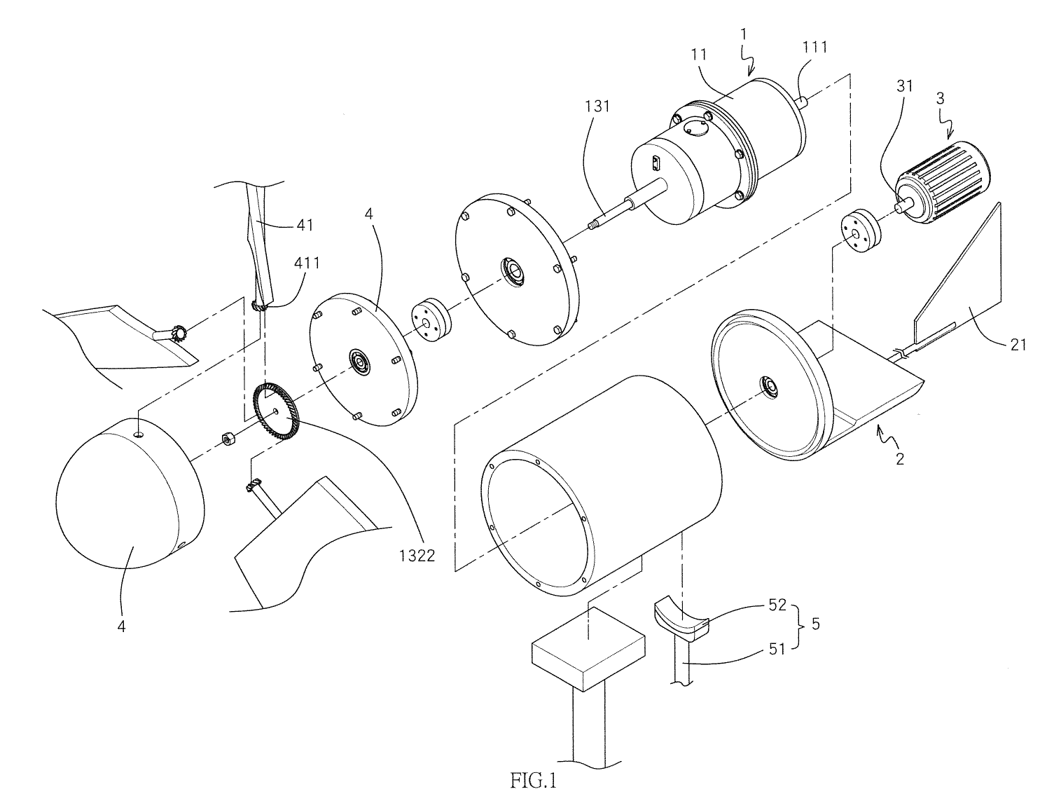

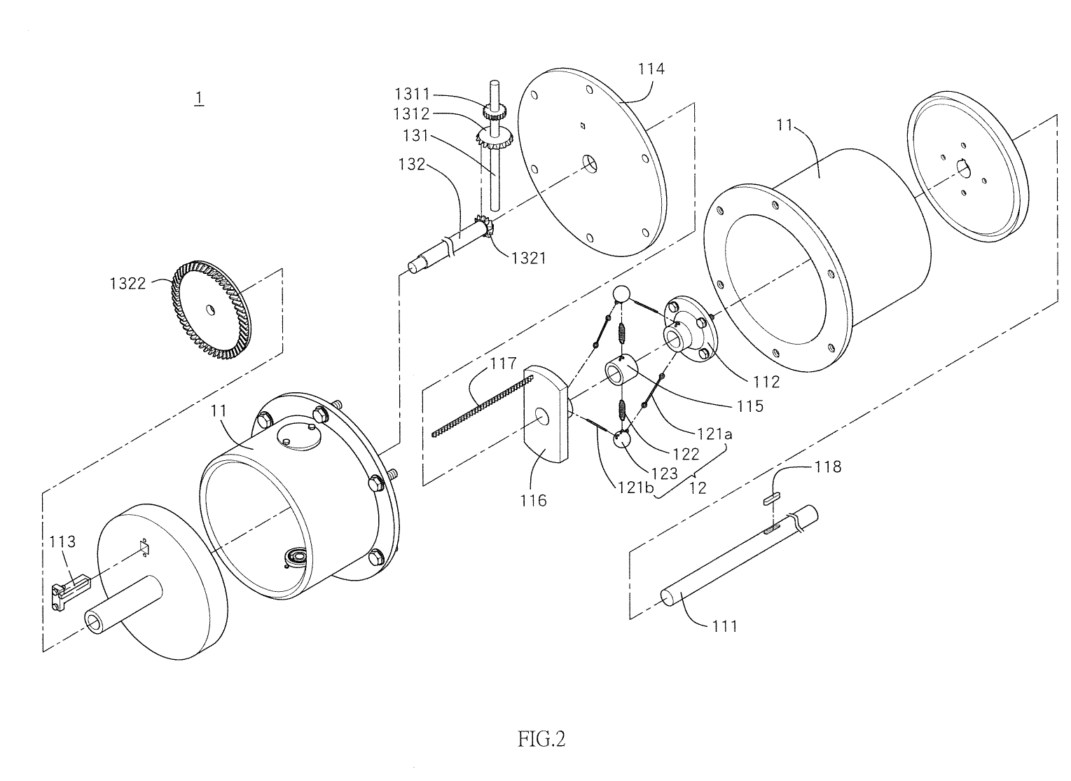

Referring to FIGS. 1 to 4, the blade speed adjustment device 1 of the present invention is installed to a support body 2 and is connected to a power generation device 3 and a base 4. The power generation device 3 comprises an output shaft 31, and the base 4 has multiple blades 41 connected thereto. The support body 2 has a tail wing 21 which pivots the support body 2 to face the wind.

The blade speed adjustment device 1 of the present invention comprises a casing 11 having a first shaft 111 extending therethrough, a flange 112, a groove 113 and a connection member 114. The first shaft 111 has a slide 115 and a passive member 116 connected thereto. One end of the first shaft 111 extends through the passive member 116 and is pivotably connected to the connection member 114 and the other end of the first shaft 111 is connected to the output shaft 31. The slide 115 has at least one centrifugal unit 12, in this embodiment, the slide 115 has two centrifugal units 12 which are located symmetrically relative to the first shaft 111 so as to enhance the stability of the present invention.

The centrifugal unit 12 has a first link 121a and a second link 121b, wherein the first link 121a is fixed to the flange 112 of the casing 11 and the second link 121b is connected to the passive member 116. The passive member 116 has a rack 117 whose distal end is movable in the groove 113 in the casing 11. The centrifugal units 12 each comprise a resilient member 122 and a block 123. The resilient member 122 is connected to the slide 115 and the block 123 is connected to a distal end of the resilient member 122. The block 123 is connected to the first and second links 121a, 121b. A key 118 is connected between the first shaft 111 and the casing 11 so that the first shaft 111 and the casing 11 are co-rotated.

A bevel gear set 13 has an axle 131 and a second shaft 132, wherein the axle 131 is perpendicular to the rack 117 and the second shaft 132 is located corresponding to the first shaft 111. The axle 131 has a right gear 1311 and a first bevel gear 1312, wherein the right gear 1311 is engaged with the rack 117, and the second shaft 132 has a second bevel gear 1321 located corresponding to the first bevel gear 1312.

The base 4 is connected to the casing 11. The second shaft 132 extends through the base 4 and has a disk gear 42 located in the base 4. Multiple blades 41 are connected to the base 4 and each blade 41 has a toothed portion 431 which is engaged with the disk gear 42.

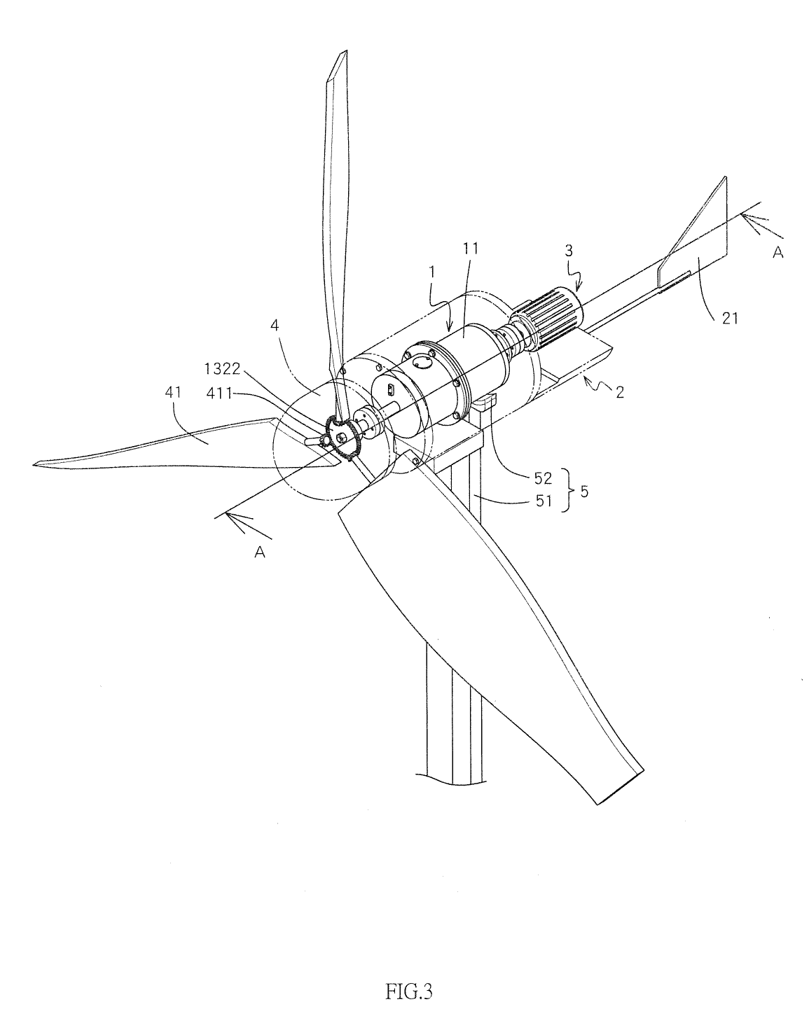

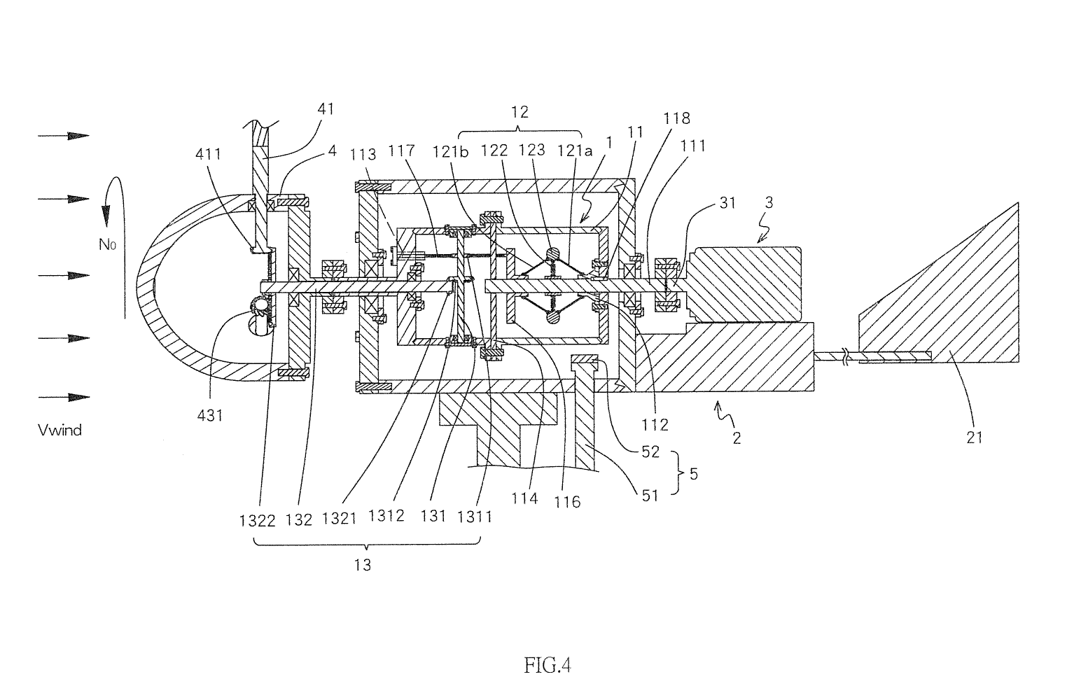

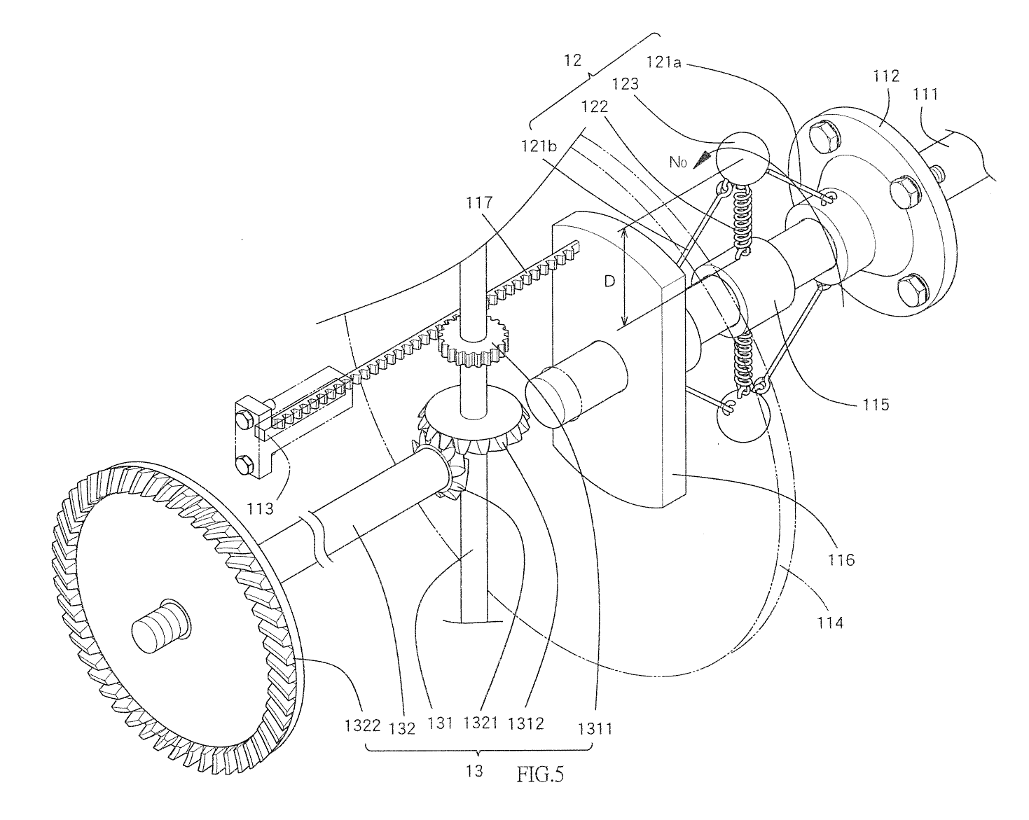

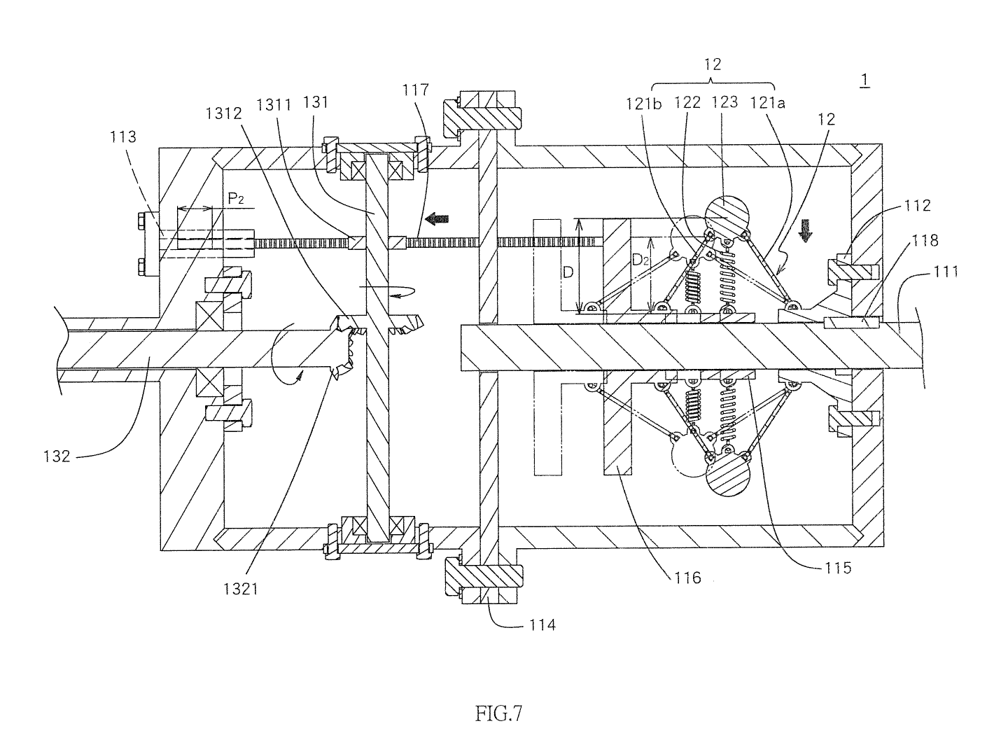

When the rotation speed of the base 4 is zero, the elevation angle of each of the blades 41 is set to face the wind so as to generate torque, so that the blades 41 rotate when wind blows to the blades 41. When wind blows, the rotation speed of the base 4 increases to drive the blade speed adjustment device 1 as shown in FIGS. 4 and 5 to 8. When the blades 41 rotate due to the wind, assume that the initial rotation speed of the base 4 is N0, the blades 41 and the base 4 are co-rotated as shown in FIGS. 3 and 4. The casing 11 is connected to the first shaft 111 by a key 118 so that when the first shaft 111 rotates, the casing 11, the first shaft 111 and the base 4 have the same rotation speed N0. The first shaft 111 drives the output shaft 31 of the power generation device 3 to generate power. The first shaft 111 also makes the centrifugal units 12 to co-rotate, the first and second links 121a, 121b move the block 123 to goes around the first shaft 111. When the first shaft 111 rotates, the centrifugal force applied to the block 123 increases. The distance between the block 123 and the first shaft 111 is represented as “D”. The passive member 116 is pulled by the block 123 via the second link 121b, and the rack 117 drives the right gear 1311 to rotate the first bevel gear 1312 via the axle 131. Because the first and second bevel gears 1312, 1321 are engaged with each other, the second bevel gear 1321 is then driven to make the second shaft 132 rotate the disk gear 1322. The rotation of the disk gear 1322 is rotated to drive the toothed portions 431 of the blades 41 to adjust the elevation angle of the blades 41.

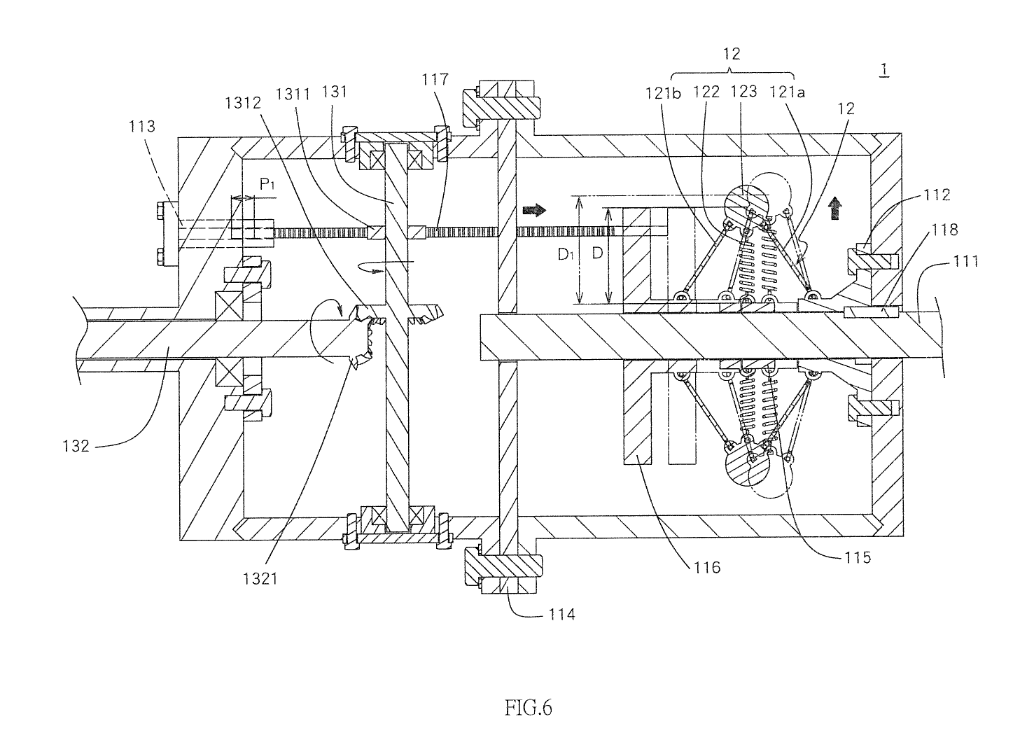

When centrifugal unit 12 rotates at the rotation speed N1 which is larger than the N0, as shown in FIG. 6, the block 123 moves away from the first shaft 111, and the D increases to be D1 due to the increase of the centrifugal force. The resilient member 122 is expanded. The first and second links 121a, 121b of the block 123 pull the passive member 116 and the rack 117, both move toward the slide 115. Assume the displacement is P1. The right gear 1311 that is engaged with the rack 117 is rotated, and the first and second bevel gears 1312, 1321 and the disk gear 1322 that is connected with the second shaft 132 are co-activated. If the rotation speed N2 of the centrifugal unit 12 is less than the initial rotation speed N0, the block 123 moves toward the first shaft 111 due to less centrifugal force is applied thereto as shown in FIG. 7. The distance “D” is reduced to be “D2”, and the resilient member 122 is compressed. The first and second links 121a, 121b push the passive member 116 and the rack 117 to move a displacement P2. In the meanwhile, the passive member 116 and the rack 117 both move away from the slide 115. This will rotate the right gear 1311, and the first and second bevel gears 1312, 1321 and the disk gear 1322 that is connected with the second shaft 132 are co-activated. Therefore, the disk gear 1322 is rotated an angle θ and the blade 41 and the toothed portion 431 are rotated an elevation angle β. That is to say, the elevation angle of each of the blades 41 is adjusted easily to increase the efficiency of power generation.

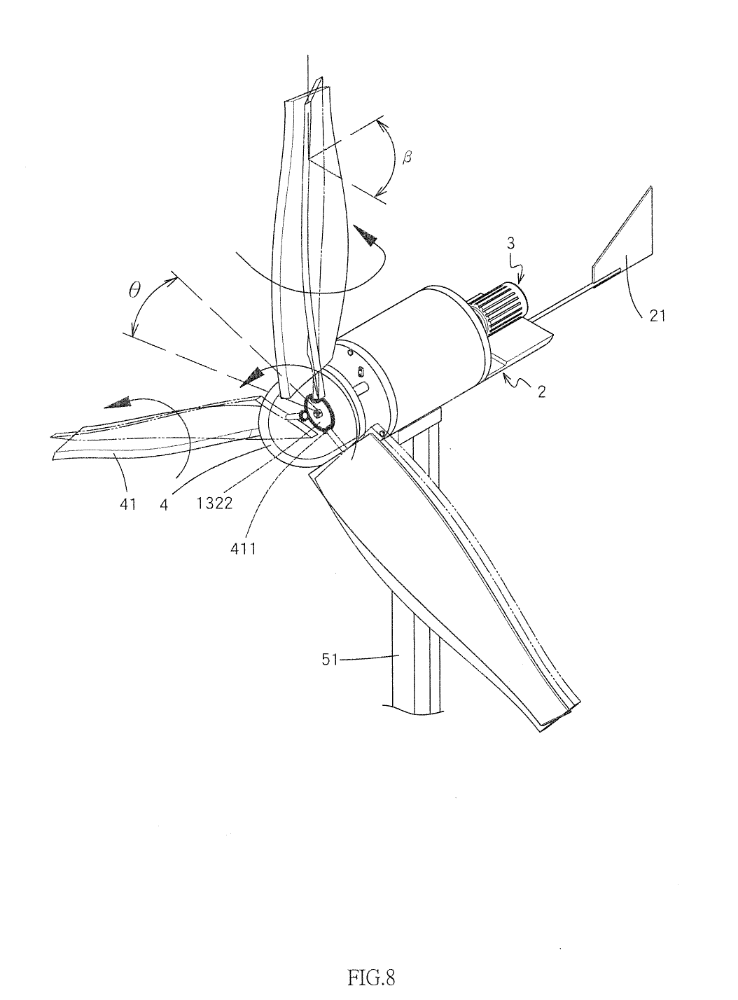

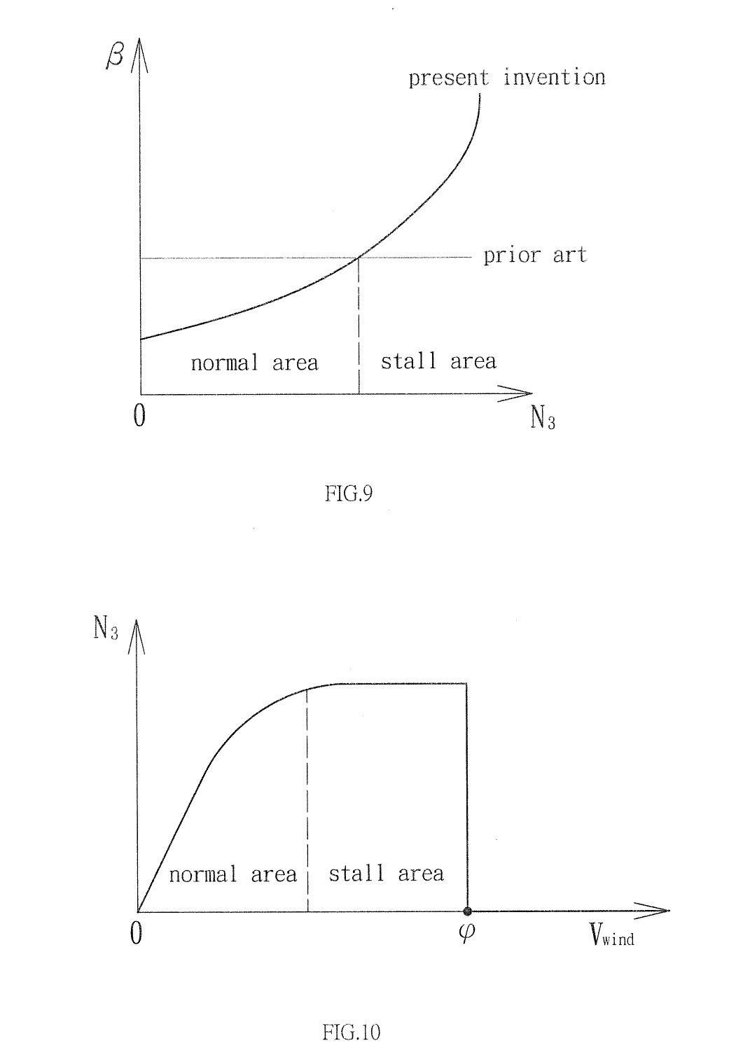

As shown in FIGS. 9 and 10, assume that the wind speed is Vwind, the elevation angle of the blade 41 that is applied by the wind is β. When the Vwind increases gradually to the initial speed that is able to rotate the blades 41. As shown in FIG. 9, assume that the rotation speed N3 of the base 4 is located within the normal range and increases along with the increasing or the Vwind, the angle θ of the disk gear 1322 gradually increases and the elevation angle β of the blade 41 increases as well. When the rotation speed N3 of the Vwind increases and reaches the area of stall as shown in FIGS. 9 and 10, the elevation angle β of the blade 41 increases to reduce the rotation speed N3 to maintain the rotation speed to be N3 under the certain wind speed Vwind. It is noted that the present invention controls the rotation speed N3 not to reach the area of stall by adjusting the elevation angle β of the blade 41. However, as shown by the conventional windmill generator, the elevation angle of the blade cannot be adjusted, so that when the wind speed Vwind increases, the rotation speed N3 increases as well so that the rotation speed enters into the area of stall.

When the wind speed Vwind exceeds over a critical value φ, the elevation angle β of the blade 41 does not increase to generate more torque, the blade 41 is parallel to the direction of the wind, the wind speed Vwind cannot rotate the blade 41 to generate torque so that the blade 41 is protected from being broken by the strong wind.

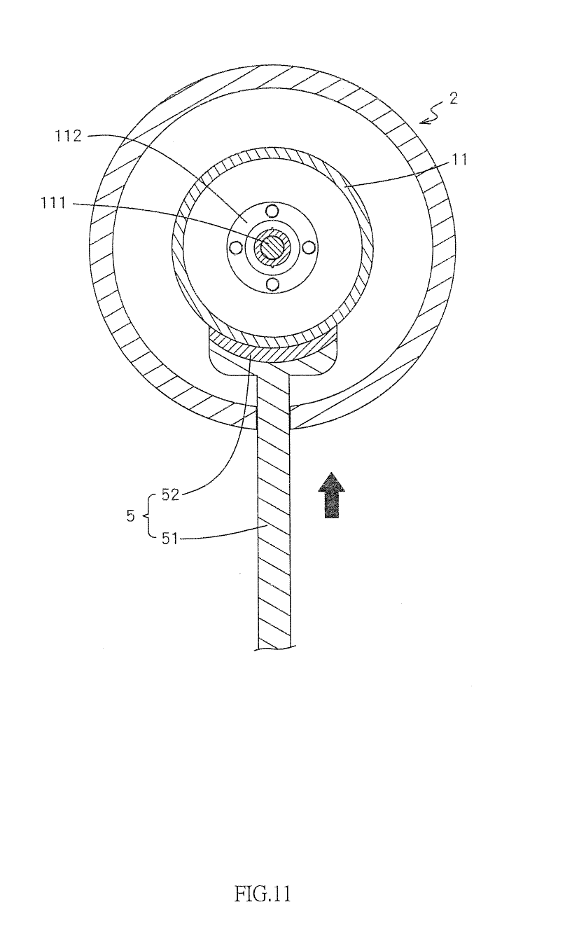

As shown in FIG. 11, in order to avoid the blade speed adjustment device 1 to be overly rotated, a mechanical brake device 5 is located outside of the casing 11 and brakes the casing 11 by contacting the casing 11. The mechanical brake device 5 comprises a brake member 51 and a brake pad 52 which is connected to the brake member 51. The brake member 51 controls the brake pad 52 to contact the outside of the casing 11. For the conventional windmill generator, an electric speed reduction device is required. The diameter of the casing 11 is large enough and provide sufficient friction area for the brake pad 52 to easily brake the casing 11.

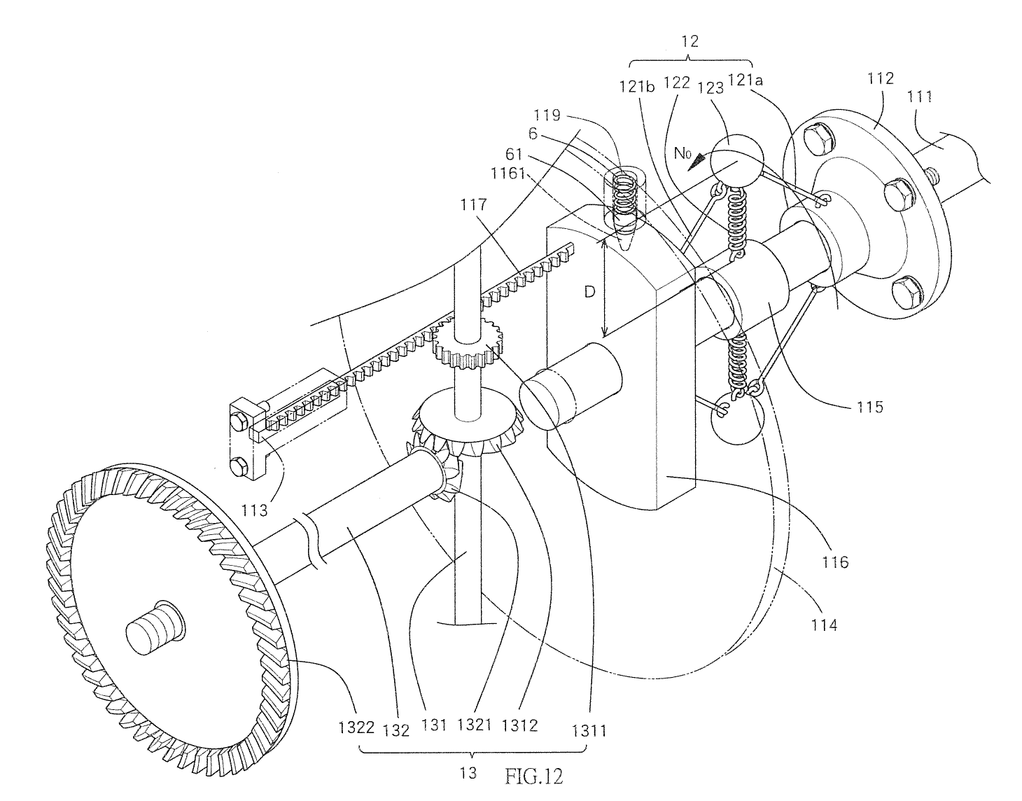

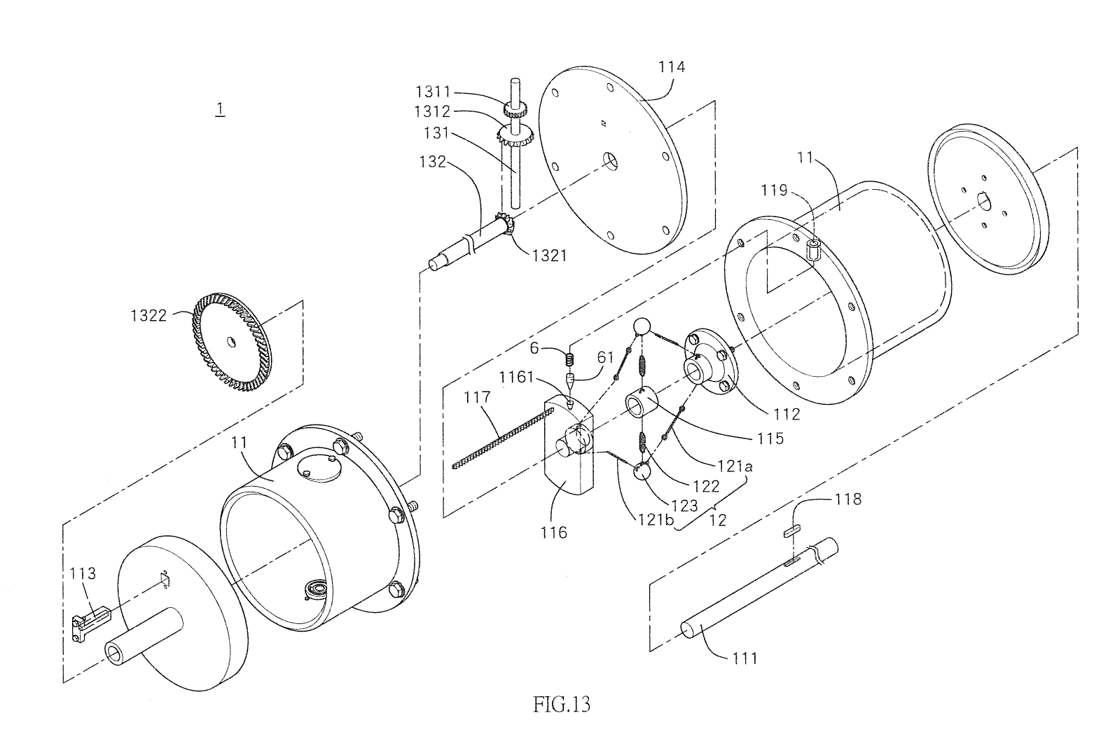

FIGS. 12 to 16 show the second embodiment of the present invention, wherein the differences from the first embodiment are the shape of the blade 41. The shape of the blade 41 allows the elevation angle of the blade to be adjusted easily. The second embodiment uses the existed blade 41′ and the casing 11 has a recess 119. A resilient unit 6 is located in the recess 119, the resilient unit 6 is connected to a control pin 61. The passive member 116 has a recess 1161 for receiving the control pin 61.

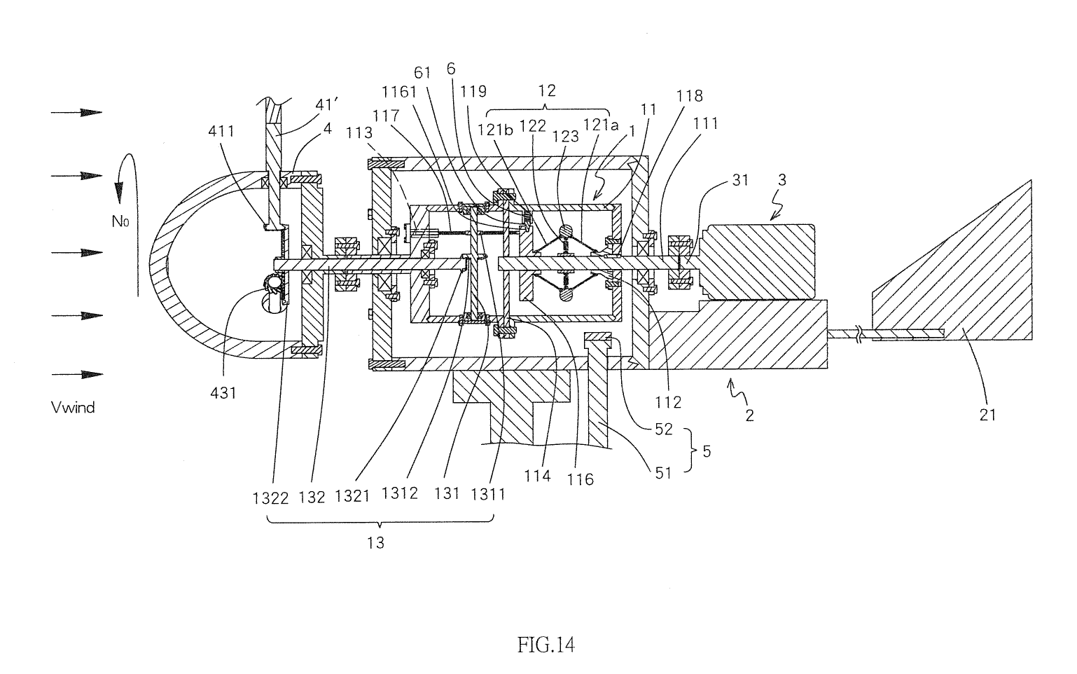

As shown in FIG. 14, when the blade 41′ is applied by the wind at the wind speed Vwind and rotates, the casing 11 and the first shaft 11 are rotated as well. Assume that rotation speed of the base 4, the casing 11 and the first shaft 111 is located within the normal area, the control pin 61 in the casing 11 is applied by the centrifugal force due to the rotation of the casing 11 cannot over the resilient force from the resilient unit 6, so that the control pin 61 is still located in the recess 1161 of the passive member 116. The passive member 116 is secured with the casing 11. Therefore, the centrifugal force of the centrifugal unit 12 cannot make the second link 121b to pull the passive member 116, so that the blade speed adjustment device 1 cannot change the elevation angle of the blade 41′ by the bevel gear set 13.

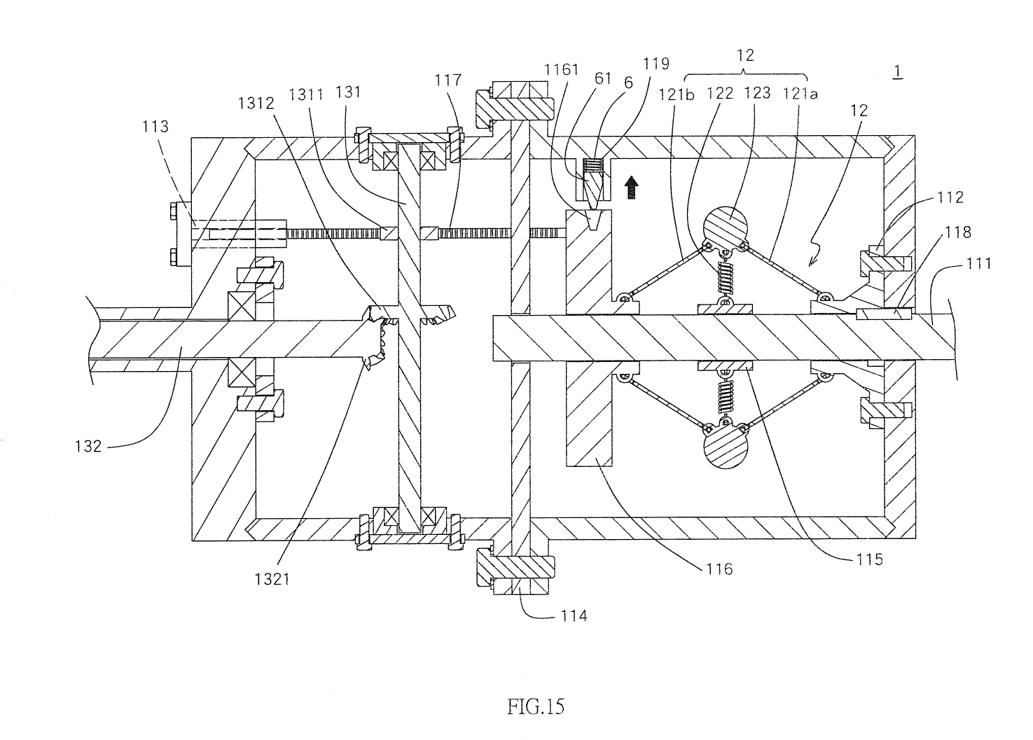

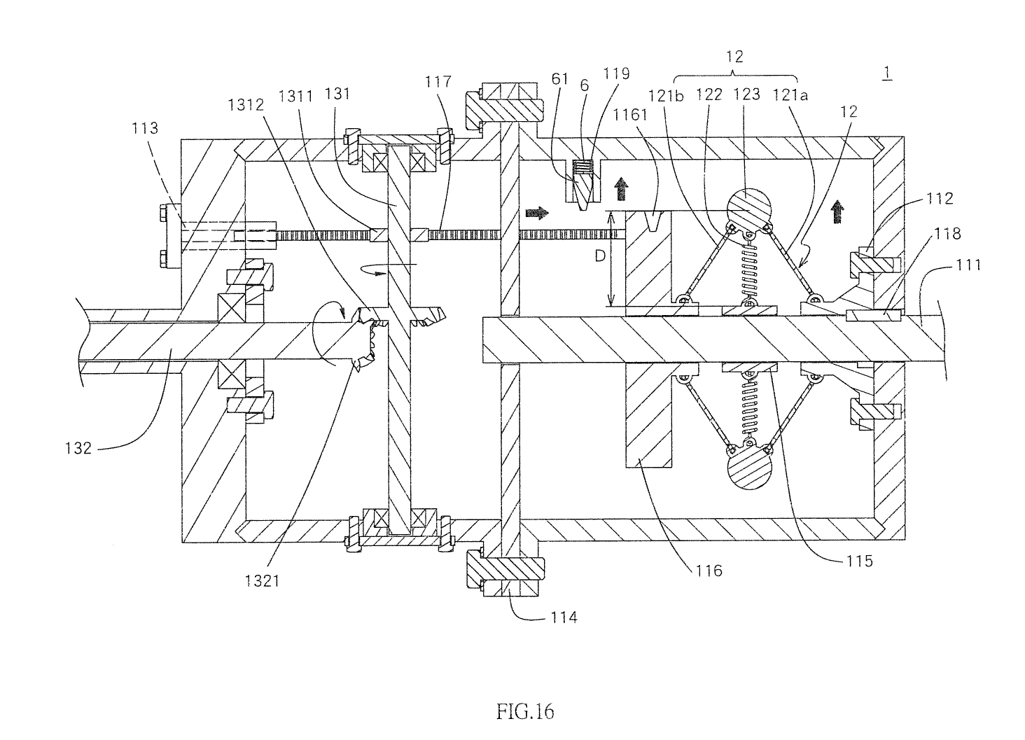

As shown in FIG. 15, when the wind speed Vwind reaches the critical value, in other words, the wind speed rotates the blade 41′ to rotate the casing 11, and the centrifugal force applied to the control pin 61 is larger than the resilient force from the resilient unit 6, the resilient unit 6 is compressed to allow the control pin 61 to remove from the recess 1161 of the passive member 116. As shown in FIG. 16, the blade 123 moves away from the first shaft 111 due to the centrifugal force so that the second link 121b pulls the passive member 116 and rack 117. The rack 117 rotates the right gear 1311 which rotates the first bevel gear 1312 via the axle 131. Because the first and second bevel gears 1312, 1321 are engaged with each other, so that the second bevel gear 1321 is driven by the first bevel gear 1312 and drives the second shaft 132 to rotate the disk gear 1322. By the rotation of the toothed portion 431 of the blade 41′ due to the rotation of the disk gear 1322, the elevation angle of the blade 41′ is adjusted quickly. In other words, the blade 41′ is parallel to the direction of the wind so that the wind cannot generate torque to the blade 41′ so that the rotation speed of the base 4 does not increase. Therefore, the rotation speed of the blade 41′ and the base 4 are maintained. The second embodiment of the present invention is suitable for the existed blade which does not need to re-designed.

While we have shown and described the embodiment in accordance with the present invention, it should be clear to those skilled in the art that further embodiments may be made without departing from the scope of the present invention.

What is claimed is:

1. A blade speed adjustment device comprising:
a casing having a first shaft extending therethrough, and the first shaft having a slide and a passive member connected thereto, the slide having at least one centrifugal unit which has a first link and a second link, the first link fixed to the casing and the second link connected to the passive member, the passive member having a rack, and
a bevel gear set having an axle and a second shaft, the axle being perpendicular to the rack and the second shaft being located corresponding to the first shaft, the axle has a right gear and a first bevel gear, the right gear engaged with the rack, the second shaft having a second bevel gear located corresponding to the first bevel gear.

2. The blade speed adjustment device as claimed in claim 1, wherein the at least one centrifugal unit comprises a resilient member and a block, the resilient member connected to the slide and the block is connected to a distal end of the resilient member, the block is connected to the first and second links.

3. The blade speed adjustment device as claimed in claim 2, wherein the slide has two centrifugal units connected thereto.

4. The blade speed adjustment device as claimed in claim 1, wherein the casing has a groove which is located corresponding to the rack, a distal end of the rack is movable located in the groove.

5. The blade speed adjustment device as claimed in claim 1, wherein the casing has a connection member connected thereto, the first shaft extends through the passive member and is pivotably connected to the connection member.

6. The blade speed adjustment device as claimed in claim 1, wherein the casing has a flange, the first link is fixed to the flange of the casing.

7. The blade speed adjustment device as claimed in claim I, wherein the casing has a recess and a resilient unit is located in the recess, the resilient unit is connected to a control pin, the passive member has a recess for receiving the control pin.

8. The blade speed adjustment device as claimed in claim 1, wherein a mechanical brake device is located outside of the casing and brakes the casing by contacting the casing.

9. The blade speed adjustment device as claimed in claim 1 further comprising a base connected to the casing, the second shaft extending through the base and having a disk gear located in the base, multiple blades connected to the base and each blade having a toothed portion which is engaged with the disk gear.

10. The blade speed adjustment device as claimed in claim 9, wherein the first shaft is connected with a power generation device.
